(19) United States
(12) Patent Application Publication
(10) Pub. No.: US 2006/0097544 A1
(43) Pub. Date: May 11, 2006

(54) AUTOMOTIVE INTERIOR TRIM ASSEMBLY AND METHOD

(76) Inventors: Glenn A. Cowelchuk, Chesterfield Township, MI (US); David Dooley, Troy, MI (US); Michael J. Hier, Milford, MI (US); Todd L. DePue, Brighton, MI (US); Randy S. Reed, Fair Haven, MI (US)

Correspondence Address: WOOD, HERRON & EVANS, LLP (LEAR), 2700 CAREW TOWER, 441 VINE STREET, CINCINNATI, OH, 45202, US

(21) Appl. No.: 10/904,408

(22) Filed: Nov. 9, 2004

(51) Int. Cl. B60J 5/00

(52) U.S. Cl. 296/146.7

(57) ABSTRACT

An automotive interior trim assembly has at least one area which provides an enhanced tactile feel that is soft to the touch. The interior trim assembly includes a substrate member forming at least part of a structural support of a trim assembly and a cover member formed of thermoplastic elastic foam supported on the substrate member. In one embodiment, the interior trim assembly is formed in a two-shot molding operation wherein a first material is molding during a first shot to form the substrate member. The cover member is molded onto the substrate member during a second shot of the molding operation to form the interior trim assembly.

### CROSS-REFERENCE

The present invention is related to U.S. Ser. No. 10/708,312, filed Feb. 24, 2004, U.S. Ser. No. 10/708,315, filed Feb. 24, 2004, U.S. Ser. No. 10/708,500, filed Mar. 8, 2004, U.S. Ser. No. 10/904,007, filed Oct. 19, 2004, U.S. Ser. No. 10/904,008, filed Oct. 19, 2004, U.S. Ser. No. 10/904,010, filed Oct. 19, 2004, U.S. Ser. No. 10/904,011, filed Oct. 19, 2004 and U.S. Ser. No. ______, filed on even date herewith [Attorney Docket No. MASL-77].

### FIELD OF THE INVENTION

The present invention relates generally to automotive interiors and, more particularly, to automotive interior trim assemblies.

### BACKGROUND OF THE INVENTION

It is known to provide automotive interiors with various trim assemblies to improve the aesthetic appearance of the automotive interior and to provide comfort and convenience to the vehicle occupants. Examples of these interior trim assemblies include instrument panels, armrests, door trim, door handles and consoles.

Conventional methods for manufacturing these trim assemblies include two-shot injection molding, wherein a first of material is injected into a mold to form a rigid substrate of the trim assembly, and a second material is injected into the mold to form a skin or cover over the rigid substrate. In certain applications, it may be desired to further improve the aesthetic appearance or functional qualities of a trim assembly by manufacturing certain areas of the trim assembly to exhibit a tactile feel that is soft to the touch. Generally, these soft-touch areas have been provided by forming a void between the skin layer and the rigid substrate during the molding process, and subsequently injecting a foam material into the void. Another conventional method involves forming a rigid substrate, placing a pre-formed foam “bun” in the area where it is desired to provide a soft-touch, and then stretching a skin layer over the rigid substrate and foam bun.

These prior methods of forming trim assemblies are manufacturing intensive, requiring multiple operations and/or manual labor to produce the soft-touch trim assemblies. The increased number of operations and manual labor result in increased manufacturing costs and inconsistent quality of the resulting trim assemblies. A need therefore exists for an automotive trim assembly having a soft-touch feel which overcomes these and other drawbacks of the prior art.

### SUMMARY OF THE INVENTION

The present invention overcomes the foregoing and other shortcomings and drawbacks of interior trim assemblies and methods of making same heretofore known. While the invention will be described in connection with certain embodiments, it will be understood that the invention is not limited to these embodiments. On the contrary, the invention includes all alternatives, modifications and equivalents as may be included within the spirit and scope of the present invention.

The present invention provides an automotive interior trim assembly that improves the aesthetic appearance of an automotive interior and provides comfort and convenience to the vehicle occupants. The trim assembly of the present invention is formed with at least one area on the trim assembly which provides an enhanced tactile feel that is soft to the touch. The interior trim assembly of the present invention can be an instrument panel, an interior door trim, an armrest, a door handle, a console, or any other interior trim component that would benefit from having at least some areas which have a soft feel.

According to one aspect of the present invention, the interior trim assembly comprises a generally rigid substrate member which forms at least part of a structural support for, and defines the general shape of, the trim assembly. A cover member formed of thermoplastic elastomer foam is supported on a predetermined area of the support member. The cover member is configured to provide an enhanced tactile feel to the trim assembly that is generally soft to the touch. The cover member is generally pliable and will deform and compress when a force, such as an occupant's arm or hand, is applied to the cover member to thereby provide the soft touch feel to the interior trim assembly.

According to another aspect of the present invention, the trim assembly is formed by a two-shot injection molding operation. During the first shot of the molding operation, a first material is injected into a mold configured to form the substrate member. The mold is then reconfigured and a second material comprising thermoplastic elastomer foam is injected into the mold to form the cover member on the predetermined area of the support member. The cover member may have a cross-sectional thickness which varies over the predetermined area of the substrate member to provide different tactile feels on different portions of the cover member. The cover member may be molded with a desired color and texture to enhance the appearance and tactile feel of the trim assembly.

The above and other objects and advantages of the present invention shall be made apparent from the accompanying drawings and the description thereof.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a front elevational view of an automotive door incorporating an exemplary automotive interior trim assembly according to the principles of present invention;

FIG. 2 is a cross-sectional view taken along line 2-2 of FIG. 1; and

FIGS. 3-8 sequentially illustrate a two-shot molding operation used to form the automotive interior trim assembly shown in FIG. 1.

### DETAILED DESCRIPTION OF THE PREFERRED EMBODIMENT

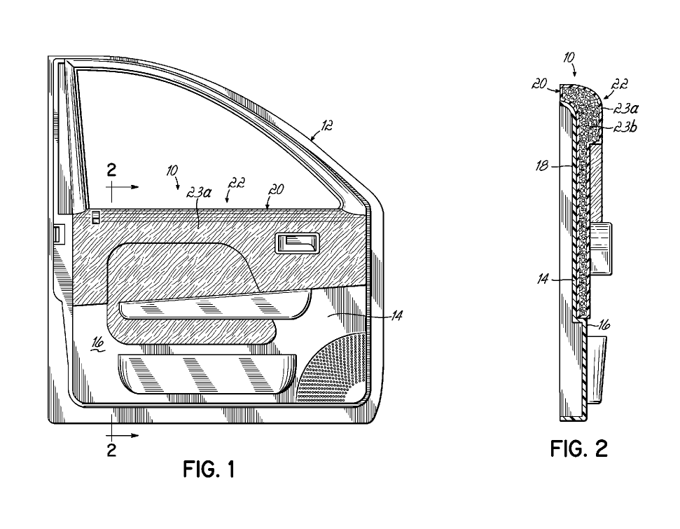

Referring to the figures, and to FIG. 1 in particular, an exemplary automotive interior trim assembly 10 is shown according to the principles of the present invention. In this embodiment, the interior trim assembly 10 is illustrated as a door trim panel which is mounted on the interior side of an automotive door 12 to improve the aesthetic appearance of the automotive interior and to provide comfort and convenience to the vehicle occupants. While the interior trim assembly 10 is illustrated and described herein in an exemplary embodiment as comprising a door trim panel, it will be appreciated that trim assembly 10 of the present invention may alternatively comprise an instrument panel, an armrest, a door handle, a console or any other interior trim component without departing from the spirit and scope of the present invention. Accordingly, the present invention is not limited to door trim panels and is applicable to other types of trim panels and trim components commonly provided in automotive interiors.

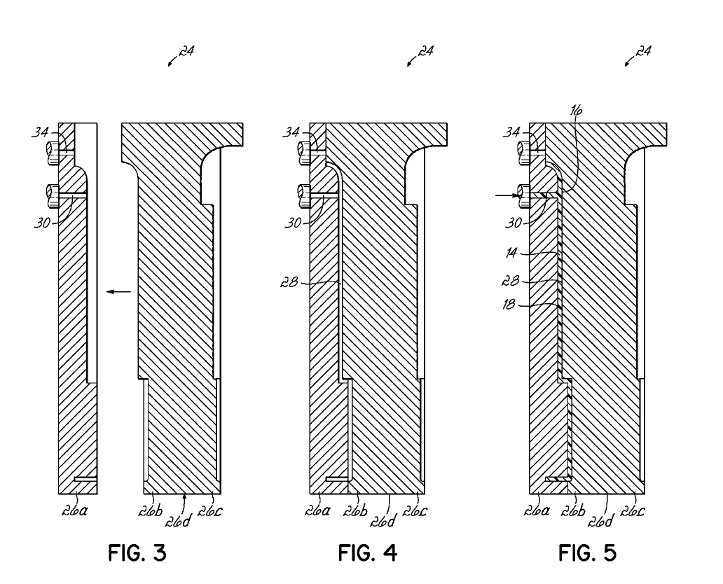

Referring now to FIGS. 1 and 2, the trim assembly 10 includes a generally rigid substrate member 14 which forms at least part of a structural support for, and defines the general shape of, the trim assembly 10. The substrate member 14 has a front surface 16 which faces the interior of the automobile and a rear surface 18 opposite to the front surface 16 which is hidden from view when the trim assembly 10 is mounted to the door 12. In one embodiment, the substrate member 14 is formed of thermoplastic olefin, acrylonitrile butadiene styrene, styrene maleic anhydride, polycarbonate/acrylonitrile butadiene styrene alloy, or any other material suitable for molding the relatively rigid substrate member 14.

In accordance with the principles of the present invention, a cover member 20 formed of thermoplastic elastomer foam is supported on a predetermined area of the substrate member 14, such as the area indicated generally by numeral 22. The cover member 20 has an outer skin 23a and an integral foam inner core 23b. The cover member 20 is configured to provide an enhanced tactile feel to the trim assembly 10 that is generally soft to the touch. The cover member 20 has a hardness which is generally lower than a hardness of the substrate member 14 so that the cover member 20 is generally pliable, soft to the feel, and will deform and compress when a force, such as a vehicle occupant's arm or hand, is applied to the cover member 20.

In one embodiment, as shown in FIG. 2, the cover member 20 has a cross-sectional thickness which varies over the predetermined area 22 of the substrate member 14. In this way, the cover member 20 can be configured to provide different tactile feels, i.e., harder or softer areas to the touch, on different portions of the cover member 20 to provide enhanced comfort to the vehicle occupant. This is accomplished by configuring the cover member 20 with thicker areas at locations where the softest feel is desired, and thinner areas at other locations where soft feel may not be as critical to occupant comfort.

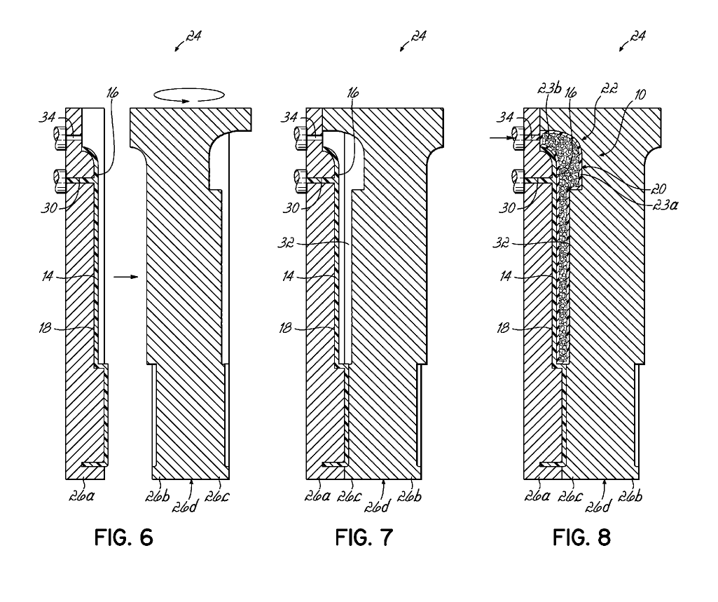

In one embodiment, as shown in FIGS. 3-8, the interior trim assembly 10 is formed in a two-shot injection molding operation. More particularly, as shown in FIGS. 3-5, the substrate member 14 of trim assembly 10 is formed during a first shot of the two-shot molding operation by injecting a first material into a mold 24 configured to form the substrate member 14. In the embodiment shown, mold 24 comprises first and second portions 26a, 26b which may be assembled together to define an interior mold cavity 28 having the generally desired shape of the substrate member 14. As shown in FIG. 5, the first material, such as thermoplastic olefin, acrylonitrile butadiene styrene, styrene maleic anhydride, polycarbonate/acrylonitrile butadiene styrene alloy, or other suitable material, is injected into the cavity 28 through a first inlet 30 formed in the first mold portion 26a which fluidly communicates at one end with an injection molding machine (not shown) and at the opposite end with the mold cavity 28.

Referring now to FIGS. 6-8, after the first material has been injected into the mold cavity 28 to form the substrate member 14, the second mold portion 26b is moved out of position and replaced with a third mold portion 26c which is configured such that the first and third mold portions 26a, 26c define a interior mold cavity 32 (FIGS. 7 and 8) for forming the cover member 20 during the second shot of the two-shot molding process. The second and third mold portions 26b and 26c may be provided on opposite sides of a rotatable mold component 26d as shown in FIGS. 3-8. Alternatively, mold portions 26b and 26c may be provided on separate mold components (not shown).

As shown in FIGS. 6-8, the substrate member 14 is retained in the mold 24 so that the cover member 16 may be formed or molded directly by overmolding on the predetermined area 22 of the substrate member 14 during the second shot of the molding operation. The first mold portion 26a includes a second inlet 34 which fluidly communicates with the injection molding machine (not shown) and the cavity 32 when the first and third mold portions 26a, 26c are assembled together. A second material comprising thermoplastic elastomer foam is injected into the cavity 32 through the second inlet 34 to form the cover member 20 on the predetermined area 22 of the substrate member 14. The molded interior trim assembly 10 is thereafter removed from the mold 24 for installation in the automobile.

It will be understood by those of ordinary skill in the art that the thermoplastic elastomer foam used to make the cover member 20 of the present invention is formed by introducing a blowing agent, such as a gas, into the molten thermoplastic elastomer resin contained within the injection molding machine (not shown). The blowing agent causes the thermoplastic resin to foam during the molding process to overmold the cover member 20 onto the substrate member 14 as described below. One suitable thermoplastic elastomer foam for use in the present invention is commercially available from Kraiberg TPE Corporation of Duluth, Ga., although other commercially available thermoplastic elastomer foams are possible as well.

In one embodiment, a gas counter pressure, which may be in a range between about 80 psi and about 200 psi for example, may be employed within the cavity 32 prior to and during the injection of the thermoplastic elastomer foam into the cavity 32 to mold the cover member 20. The gas counter pressure is used to keep the blowing agent or gas in solution in the resin as the thermoplastic elastomer foam resin is injected within the mold cavity 32 during the second shot. During the overmolding process, the thermoplastic elastomer foam resin cools to form the outer skin 23a of the cover member 20. The mold cavity 32 is vented to atmosphere generally at the completion of the second shot which causes the blowing agent or gas to come out of solution with the resin to form the foam inner core 23b.

In one embodiment, the cover member 20 is cohesively bonded with the substrate member 14 during the two-shot molding process. In this way, the cover member 20 bonds directly to the substrate member 14 during the two-shot molding operation. The substrate member 14 may contain some residual heat from the first shot when the second shot is performed, although such residual heat is not required to form the cohesive bond. Accordingly, the substrate member 14 may be molded and then allowed to cool to room temperature before the cover member 20 is overmolded onto the predetermined area 22 of the substrate member 14.

A mechanical interlock (not shown) may also be provided to enhance securement of the cover member 20 on the substrate member 14. For example, the substrate member 14 may be formed with one or more apertures (not shown) during the first shot of the molding process. During the second shot, the thermoplastic elastic foam forming the cover member 20 extrudes through the apertures formed in the substrate member 14. As the thermoplastic elastomer foam expands within the mold cavity 32, it forms stem portions (not shown) extending through the apertures (not shown) and enlarged head portions (not shown) rearwardly of the apertures (not shown) so as to mechanically interlock the substrate member 14 and cover member 14 together. Of course, other mechanical interlocks known to those of ordinary skill in the art are possible as well.

According to another aspect of the present invention, a coloring agent may be mixed with the thermoplastic elastomer resin prior to the second shot of the molding operation. This allows the cover member 20 to be molded with a desired color. Also, while not shown, it will be appreciated that all or selected portions of the third mold portion 26c may be textured to provide a desired textured surface on the outer skin 23a of the cover member 20 facing the interior of the automobile. The first mold portion 26a may also be textured to provide a desired textured surface on portions of the substrate member 14 which are not covered by the cover member 20.

While the present invention has been illustrated by the description of an exemplary embodiment thereof, and while the embodiment has been described in considerable detail, it is not intended to restrict or in any way limit the scope of the appended claims to such detail. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of Applicants' general inventive concept.

What is claimed is:

1. An automotive interior trim assembly, comprising:
a substrate member forming at least part of a structural support of a trim assembly; and
a cover member supported on a predetermined area of said substrate member and comprising a thermoplastic elastomer foam.

2. The automotive interior trim assembly of claim 1, wherein said cover member has a hardness which is generally lower than a hardness of said substrate member.

3. The automotive interior trim assembly of claim 1, wherein said substrate member is formed from a material comprising one of thermoplastic olefin, acrylonitrile butadiene styrene, styrene maleic anhydride and polycarbonate/acrylonitrile butadiene styrene alloy.

4. The automotive interior trim assembly of claim 1, wherein said cover member has a cross sectional thickness which varies over the predetermined area of said substrate member.

5. The automotive interior trim assembly of claim 1 configured as door panel for an automobile.

6. A method of forming an automotive interior trim assembly, comprising the steps of:
molding a first material to form a substrate member; and
molding a second material comprising thermoplastic elastomer foam onto the substrate member to form a cover member on the substrate member.

7. The method of claim 6, wherein the cover member is molded onto a predetermined area of the substrate member.

8. The method of claim 7, wherein the cover member has a cross-sectional thickness which varies over the predetermined area of the substrate member.

9. The method of claim 6, wherein the first material comprises one of thermoplastic olefin, acrylonitrile butadiene styrene, styrene maleic anhydride and polycarbonate/acrylonitrile butadiene styrene alloy.

10. A method of forming an automotive interior trim assembly in a two-shot molding operation, comprising the steps of:
molding a first material to form a substrate member during a first shot of the molding operation; and
molding a second material comprising thermoplastic elastomer foam onto the substrate member to form a cover member on the substrate member during a second shot of the molding operation.

11. The method of claim 10, wherein the cover member is molded onto a predetermined area of the substrate member.

12. The method of claim 11, wherein the cover member has a cross-sectional thickness which varies over the predetermined area of the substrate member.

13. The method of claim 10, wherein the first material comprises one of thermoplastic olefin, acrylonitrile butadiene styrene, styrene maleic anhydride and polycarbonate/acrylonitrile butadiene styrene alloy.

14. A method of forming an automotive interior trim assembly in a two-shot molding operation, comprising the steps of:
forming a first mold cavity in a mold;
molding a first material within the first mold cavity to form a substrate member during a first shot of the molding operation;
reconfiguring the mold to form a second mold cavity; and
molding a second material comprising thermoplastic elastomer foam onto the substrate member in the second mold cavity to form a cover member on the substrate member during a second shot of the molding operation.

15. The method of claim 14, wherein the cover member is molded onto a predetermined area of the substrate member.

16. The method of claim 15, wherein the cover member has a cross-sectional thickness which varies over the predetermined area of the substrate member.

17. The method of claim 14, wherein the first material comprises one of thermoplastic olefin, acrylonitrile butadiene styrene, styrene maleic anhydride and polycarbonate/acrylonitrile butadiene styrene alloy.
